(19) United States
(12) Patent Application Publication
(10) Pub. No.: US 2025/0167615 A1
(43) Pub. Date: May 22, 2025

(54) ANISOTROPIC INTERLEAVED COIL SLOTS USING ADDITIVE MANUFACTURING FOR MAXIMIZING ELECTRIC MOTOR TORQUE

(71) Applicant: BOARD OF TRUSTEES OF THE UNIVERSITY OF ARKANSAS, Little Rock, AR (US)

(72) Inventor: Roy McCann, Fayetteville (AR)

(73) Assignee: BOARD OF TRUSTEES OF THE UNIVERSITY OF ARKANSAS, Little Rock, AR (US)

(21) Appl. No.: 18/838,991

(22) PCT Filed: Feb. 15, 2023
(86) PCT No.: PCT/US2023/013155

§ 371 Date: Aug. 15, 2024

Related U.S. Application Data
(60) Provisional application No. 63/311,022, filed on Feb. 16, 2022.

(51) Int. Cl. H02K 3/26; B33Y 10/00; B33Y 80/00; H02K 15/0407

(52) U.S. Cl. CPC H02K 3/26; B33Y 10/00; B33Y 80/00; H02K 15/0407

(57) ABSTRACT

An electric machine includes a stator having an axial bore, a rotor positioned in the axial bore with an airgap between the stator and the rotor, radial slots formed in the stator extending radially relative to the axial bore, where each radial slot of the radial slots has a slot length extending radially from an inner end to an outer end and a slot width less than or equal to an airgap length of the airgap, and the each radial slot filled with copper forming radial copper plates, where each radial copper plate is electrically connected to other radial copper plates.

### TECHNICAL FIELD

This disclosure relates in general to the field of electric machines, and more particularly, but not by way of limitation, to electric machines with anisotropic interleaved radial stator slots.

### BACKGROUND

This section provides background information to facilitate a better understanding of the various aspects of the disclosure. It should be understood that the statements in this section of this document are to be read in this light, and not as admissions of prior art.

The recent increased use of electric motors in electric vehicles, wind and renewable energy generation, aircraft electric propulsion, drones, and robotics has highlighted the need for electric machines and actuators that possess increased torque density (newton-meters per volume and per kilogram) and maximized energy efficiency. Although there have been improvements in materials and automation, existing motors today continue to rely upon methods developed in the 1970s of forming copper wire into coils that are subsequently inserted into the slots of a laminated stator assembly. Consequently, recent trends for transportation electrification and robotics has placed an emphasis on motor designs that increase the number of slots and the slot fill percentage (i.e., the proportion of area occupied by copper conductors). In addition, the need for very high efficiency motor drive power electronics has led to the adoption of extremely fast switching wide-bandgap semiconductors. Although fast transistor switching speeds have resulted in high efficiency power electronics that provide power for electric motors, the fast-switching characteristics have negative consequences for the motor.

Specifically, fast switching power electronics results in capacitive currents being induced between adjacent motor windings. This results in breakdown of electrical insulation between coils and premature motor failures. Another emerging challenge is reducing torque ripple (i.e., torque error and variability) for robotic applications. This is a consequence of the benefits of direct-drive actuators that eliminate gear mechanisms between the motor shaft and mechanical load elements (grippers, arms, clamps, end effectors, etc.). Direct-drive configurations minimize inertia and vibration, while also eliminating gear backlash, and improve position controllability. However, this places more requirements in electric motor torque accuracy and precision. Recent trends have been towards higher numbers of pole-slots in electric motors, which further exacerbates the challenges of achieving high slot fill factors.

### SUMMARY

An exemplary electric machine includes a stator having an axial bore, a rotor positioned in the axial bore with an airgap between the stator and the rotor, radial slots formed in the stator extending radially relative to the axial bore, where each radial slot of the radial slots has a slot length extending radially from an inner end to an outer end and a slot width less than or equal to an airgap length of the airgap, and the each radial slot filled with copper forming radial copper plates, where each radial copper plate is electrically connected to other radial copper plates.

An exemplary method for making an electrical machine includes producing a stator having an axial bore and radial slots extending radially a slot length relative to the axial bore from an inner end to an outer end and a slot width that is less than an airgap for the electric machine when a rotor is positioned in the axial bore, filling each radial slot of the radial slots with copper thereby creating radial copper plates, and making electrical interconnections between the radial copper plates.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion. As will be understood by those skilled in the art with the benefit of this disclosure, elements and arrangements of the various figures can be used together and in configurations not specifically illustrated without departing from the scope of this disclosure.

FIG. 1 is a section view of an exemplary prior art 24-slot, 4-pole motor with twenty-one conductors per slot.

FIG. 2 is a section view of an exemplary electric machine according to aspects of the disclosure with 240 ampere-tern slots.

FIG. 3 is a magnified view of a portion of the electric machine of FIG. 2.

FIG. 4 is a magnified view illustrating features of exemplary anisotropic interleaved radial stator slots.

FIG. 5 is a partial view of an exemplary electric machine showing anisotropic interleaved layers of the radial stator slots.

FIG. 6 illustrates exemplary conductor interconnections for an exemplary full pitch, 90 degree, winding design.

FIG. 7 is a section view of another exemplary winding interconnection of the radial slot conductors.

FIG. 8 is a three-dimensional rendering of an exemplary wave winding interconnection of the radial slot conductors.

FIG. 9 is a three-dimensional rendering of an exemplary wave winding interconnection of the slot conductors.

FIG. 10 is a block diagram illustrating an exemplary method for making an electric machine according to aspects of the disclosure.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

This invention is a new paradigm for electric motor design and manufacturing that is enabled by copper additive manufacturing (copper 3D printing) with copper die-casting to achieve 100 percent slot fill. This allows innovative new designs that maximize motor torque density (newton-meters per unit volume). This is achieved by discarding existing methods of using copper wire and/or pre-formed copper bars.

In brief, instead of conventional coils and slots, the stator is made up of a stack of steel laminations that have radially oriented flat voids into which copper is filled using a copper die-casting process. Metallic additive manufacturing (copper 3D printing) is then used to make the electrical interconnections between the radial copper plates. An alternative embodiment of the invention would use 3D copper printing for each stator lamination stack which would preclude the use of die-casting operations.

For those experienced in electric motor design will follow guidelines that stator slot widths must be greater that the rotor airgap length. This is normally a valid approach in order to avoid leakage flux that reduces motor torque. This invention has confirmed a new design approach where the slot width is approximately equal to or less than the airgap length. In addition, an innovative approach where interleaved embedded slots are introduced that introduces magnetic anisotropic features into the stator. These two attributes of the invention are not obvious to those experienced in the contemporary art of electric motor design. However, the approaches disclosed by this invention result in greater than fifty percent increases in motor torque per volume and mass.

The result is that the new method achieves 100 percent slot fill and greater than 10× increase in the number of slots and slot density compared to existing state-of-the-art methods. With respect to current industry practices, this invention achieves a fifty to seventy percent increase in torque density. The invention achieves this by minimizing magnetic flux leakage, effectively eliminating inter-winding capacitance, and minimizing conductor thermal impedance to outer casing/housing. In addition, the invention minimizes torque ripple variation by eliminating magnetic detent (“cogging”) torque and achieving near perfect winding factors that minimize slot harmonics and maximize average torque production.

In the process of designing the coil winding for an electric motor, the result is a determination of the number of ampere-turns needed in order to achieve the required performance specifications. For existing state-of-the-art motor designs, the ampere-turns are converted into a configuration of coils.

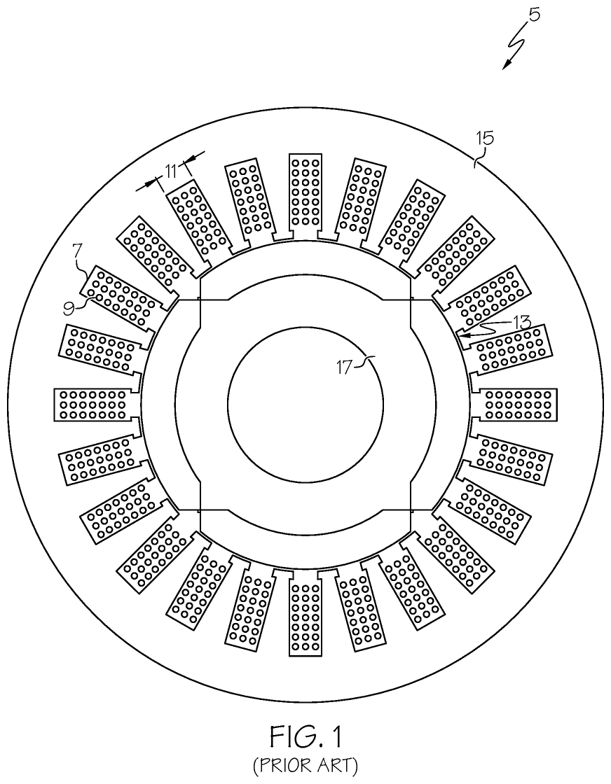

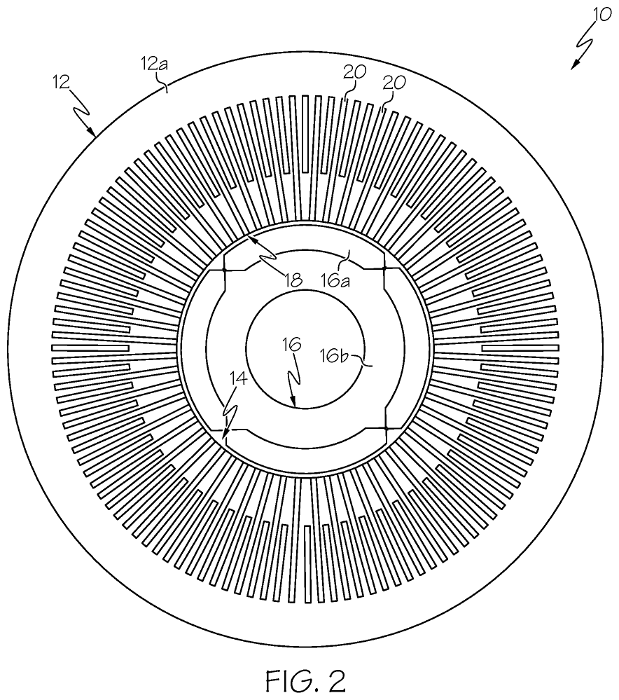

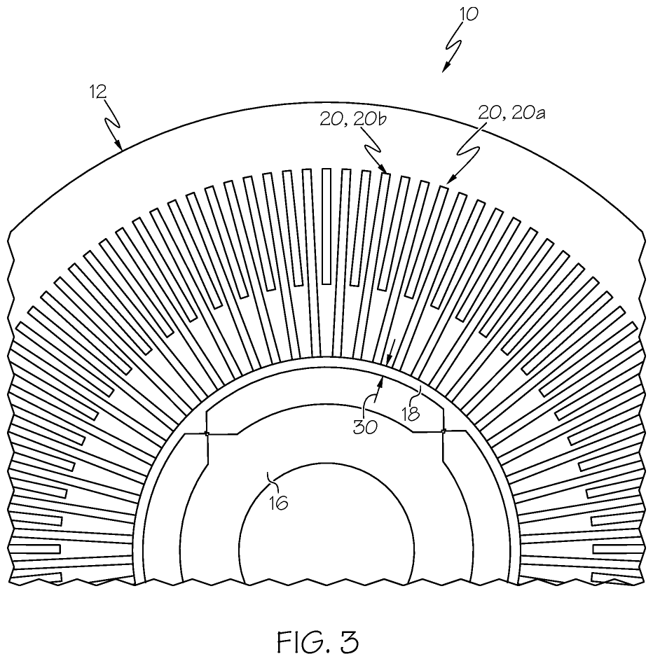

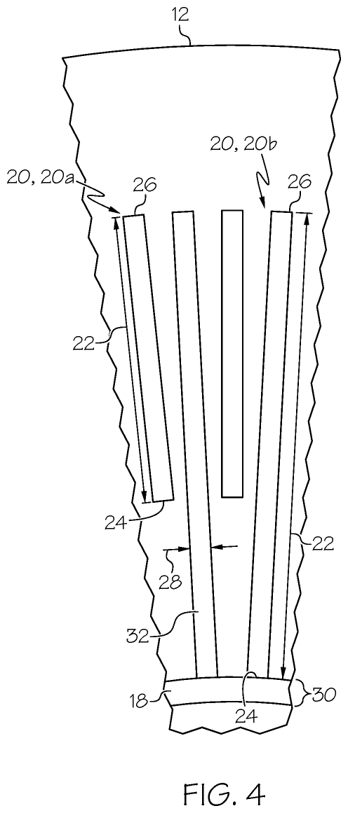

FIG. 1 is a section view of a conventional, prior art, 24-slot 4-pole 3-phase motor 5. Each stator slot 7 contains twenty-one conductors 9 and results in 168 total conductors per phase. When accounting for electrical insulation, this corresponds to approximately 60 percent slot fill. Each stator slot 9 has a width 11 that is greater than the airgap length 13 between the stator 15 and the rotor 17. In contrast, this invention (see, e.g., FIGS. 2-5) assigns a stator slot 20 to each conductor 32. This forms plate-shaped copper structures 32 oriented radially away from the stator bore 14.

FIGS. 2-9 illustrate exemplary aspects of an innovative electric machine 10 according to aspects of the disclosure. Electric machine 10 includes a stator 12 having an axial bore 14 and a rotor 16 positioned in axial bore 14 with an airgap 18 between stator 12 and rotor 16. Rotor 16 may include rotor magnets 16a and rotor iron 16b. Stator 12 is constructed of a stacked stator laminations 12a. Radial slots 20 are formed in stator 12 and extend radially relative to axial bore 14. Each radial slot 20 has a slot length 22 extending radially from an inner end 24 to an outer end 26. Outer end 26 of all the slots may be located at same radial distance from airgap 18. Each radial slot 20 has a slot width 28 that is less than or equal to an airgap length 30. Each radial slot 20 is filled with copper 32 forming radial copper plates 32. The radial copper plates 32 are interconnected by electrical connections 34.

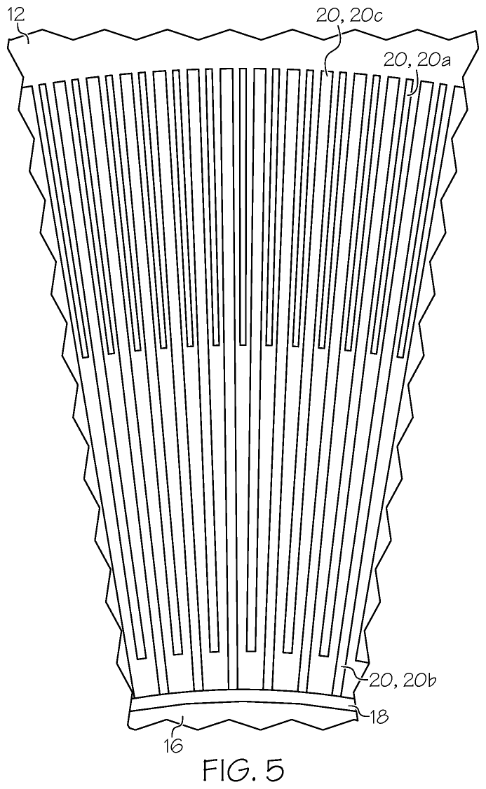

The exemplary stator illustrated in FIGS. 2-4 includes first radial slots 20a interleaved with second radial slots 20b having a different slot length than first radial slots 20a. In this example first radial slots 20a are shorter slots forming an interleaved outer row of conductors 32 with respect to the longer second radial slots 20b. The electric machine may include more than two rows, or layers, of interleaved radial slots. FIG. 5 illustrates three rows or layers of anisotropic interleaved radial slots to further optimize magnetic flux coupling. The example of FIG. 5 illustrates interleaved first radial slots 20a, second radial slots 20b, and third radial slots 20c. In this example, at least the slot length of the interleaved first, second and third radial slots is different.

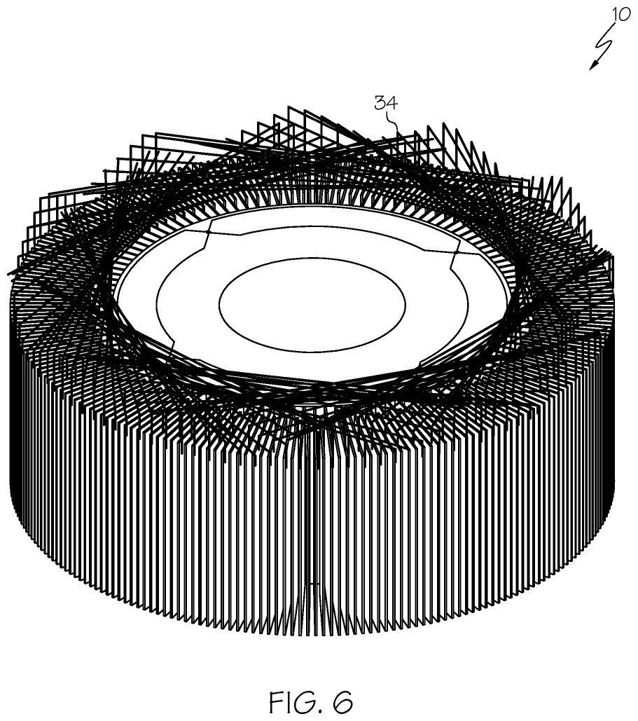

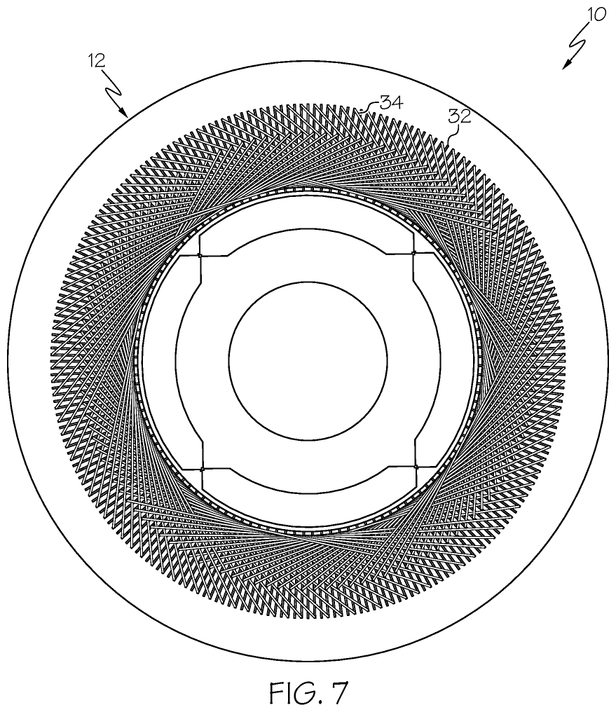

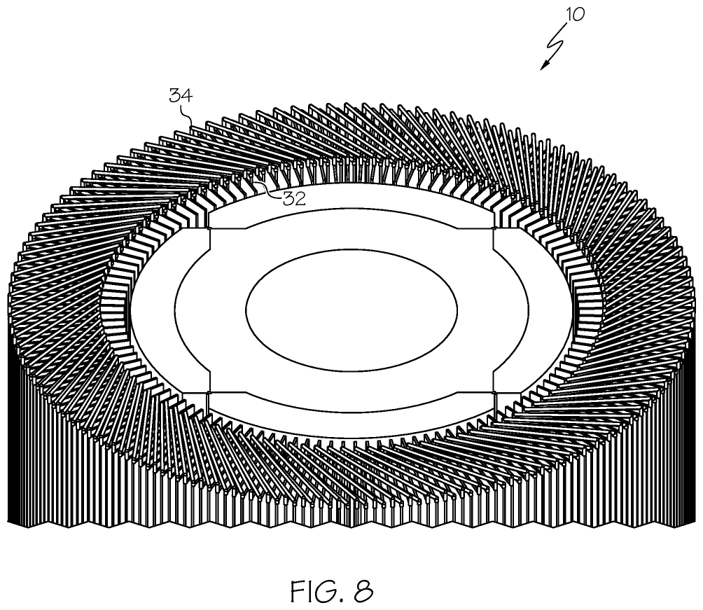

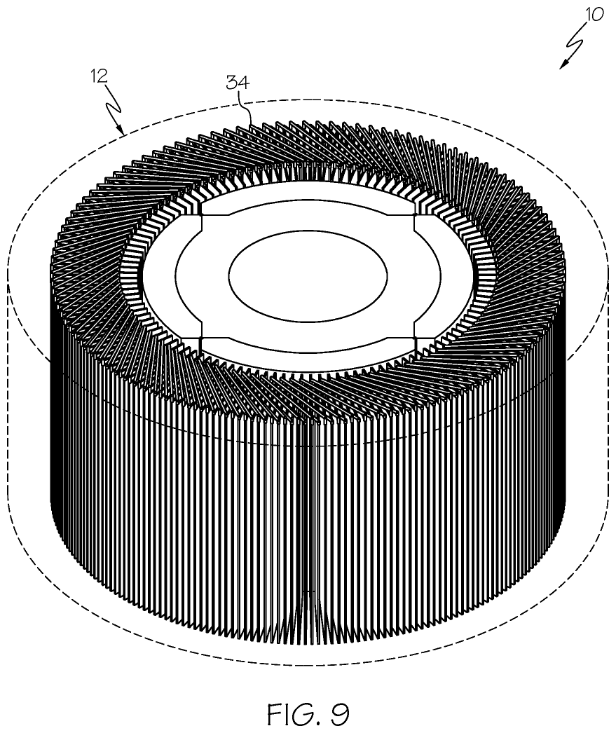

Stator copper conductors 32 can be formed using copper die-casting methods. Alternatively, the stator laminations could be filled with copper using metallic 3D printing methods. Each of the copper slot conductors 32 are then joined electrically (interconnections 34) using metallic additive manufacturing (copper 3D printing). A three-dimensional view of exemplary interconnections 34 is shown in FIG. 6 for a full pitch winding (i.e., 90 degrees for a 4-pole motor). Alternatively, a two-dimensional section view of a wave winding interconnection 34 is shown in FIG. 7. Corresponding three-dimensional renderings of these windings are shown in FIGS. 8 and 9.

The geometric aspects of an exemplary electric machine include stator slot widths 28 that are approximately the same or less than the rotor airgap length 30 and two or more layers 20a, 20b, 20c of interleaved stator slots 20 that form anisotropic magnetic flux paths embedded within the stator laminations 12a.

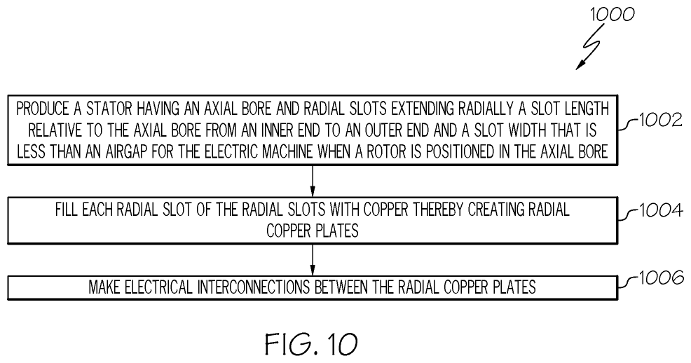

FIG. 10 illustrates an exemplary method 1000 for making an electric machine, which is described with reference to FIGS. 2-9. At block 1002, a stator 12 is produced having an axial bore 14 and radial slots 20 extending radially a slot length 22 from an inner end 24 to an outer end 26 and a slot width 28 that is less than an airgap length 30 for the electric machine when a rotor 16 is positioned in the axial bore. At block 1004, filling each radial slot 20 with copper 32 thereby creating radial copper plates. In exemplary embodiments, the copper plates fill 100 percent of the radial slot. At block 1006, making electrical interconnections between the radial copper plates.

It is noted that this invention is not obvious for those experienced in electric motor design. Practitioners will follow guidelines which advise that stator slot widths must be greater that the rotor airgap length. This is normally a valid approach in order to avoid leakage flux that reduces motor torque. This invention has verified a new design approach where the slot width is approximately equal to or less than the airgap length. In addition, an innovative approach where interleaved embedded slots are introduced that create magnetic anisotropic features into the stator. These two attributes of the invention are not obvious to those experienced in the contemporary art of electric motor design. The approaches disclosed by this invention result in greater than 50 percent increases in motor torque per volume and mass.

The invention leverages ongoing development in copper die-casting and metallic 3D printing. To date, copper die-casting for electrical machinery has only been employed as an improvement to aluminum in die-cast squirrel-cage induction motors. Copper die-casting offers higher motor efficiency compared to aluminum due to the higher electrical conductivity of copper. However, copper die-casting is challenging due to the higher melting temperature of copper compared to aluminum. However, all existing methods have been developed for motors with a conventional lamination slot geometry. In addition, it is noted that for a squirrel cage motor, all of the rotor conductors are electrically connected together at the end bell region. Consequently, a squirrel cage die-casting is not suitable for performing the functions of a three-phase AC stator winding.

To verify the benefits of the invention compared to existing state-of-the-art motors, a four-pole permanent magnet motor design has been evaluated analytically using two-dimensional magnetostatic finite element analysis of the motor flux density. The same rotor magnets and outside diameters were used in developing the comparison. In this case, the optimistic limits of existing best-in-class methods to achieve 83 percent slot fill using pre-formed hairpin coils were analyzed. Using a current density of 8 A/mm2 resulted in 1.12 Nm of torque. For this invention using anisotropic interleaved lamination slots with copper additive manufacturing resulted in 1.74 Nm of torque using the same 8 A/mm2 current density. This is a fifty-five percent increase in torque when compared to best-in-class state-of-the-art motor technologies. This increase in torque is attributed to the greatly reduced flux leakage or equivalently, the increase flux linkage in the stator windings.

In addition, the anisotropic interleaved slot approach reduces electrical losses in the stator. In particular, eddy-currents are significantly reduced in the anisotropic interleaved slot design. In addition, there is improved thermal conductivity due to the increased surface area achieved by the narrow slot width. This enables higher current density for the same operating temperature. Overall, it is conservatively anticipated that this invention will achieve at least sixty to seventy-five percent increases in motor torque.

Although relative terms such as “outer,” “inner,” “upper,” “lower,” and similar terms have been used herein to describe a spatial relationship of one element to another, it is understood that these terms are intended to encompass different orientations of the various elements and components in addition to the orientation depicted in the figures. Furthermore, as used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements. The terms “substantially,” “approximately,” “generally,” and “about” are defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An electric machine, comprising:
a stator having an axial bore;
a rotor positioned in the axial bore with an airgap between the stator and the rotor;
radial slots formed in the stator extending radially relative to the axial bore, wherein each radial slot of the radial slots has a slot length extending radially from an inner end to an outer end and a slot width less than or equal to an airgap length of the airgap; and
the each radial slot filled with copper forming radial copper plates, wherein each radial copper plate of the radial copper plates is electrically connected to another radial copper plate of the radial copper plates.

2. The electric machine of claim 1, wherein the slot width of the each radial slot is less than the airgap length.

3. The electric machine of claim 1, wherein the each radial slot is flat.

4. The electric machine of claim 1, wherein the each radial slot holds a single radial copper plate of the radial copper plates.

5. The electric machine of claim 1, wherein the copper fills 100 percent of the each radial slot.

6. The electric machine of claim 1, wherein the radial slots comprise interleaved first radial slots and second radial slots, wherein at least one selected from the slot length and the slot width is different between the first radial slots and the second radial slots.

7. The electric machine of claim 6, wherein the copper fills 100 percent of the each radial slot.

8. The electric machine of claim 7, wherein the slot length of the first radial slots and the second radial slots is different.

9. The electric machine of claim 6, wherein the outer end of the each radial slot of the radial slots is located at a same radial distance from the airgap.

10. The electric machine of claim 9, wherein the first radial slots are shorter than the second radial slots.

11. The electric machine of claim 1, wherein the radial slots comprise anisotropic interleaved first radial slots, second radial slots, and third radial slots.

12. A method for making an electrical machine, comprising:
producing a stator having an axial bore and radial slots extending radially a slot length relative to the axial bore from an inner end to an outer end and a slot width that is less than an airgap for the electric machine when a rotor is positioned in the axial bore;
filling each radial slot of the radial slots with copper thereby creating radial copper plates; and
making electrical interconnections between the radial copper plates.

13. The method of claim 12, wherein the slot width along the slot length is less than or equal to the airgap.

14. The method of claim 12, wherein the copper fills 100 percent of the each radial slot.

15. The method of claim 12, wherein the radial slots comprise interleaved first radial slots and second radial slots, wherein at least one selected from the slot length and the slot width is different between the first radial slots and the second radial slots.

16. The method of claim 15, wherein the slot length of the first radial slots and the second radial slots is different.

17. The method of claim 15, wherein the outer end of the each radial slot of the radial slots is located at a same radial distance from the airgap.

18. The method of claim 17, wherein the first radial slots are shorter than the second radial slots.

19. The method of claim 12, wherein the radial slots comprise interleaved layers of the radial slots, wherein at least one selected from the slot length and the slot width is different for the radial slots of each layer of the interleaved layers from the radial slots of other layers of interleaved layers.

20. The method of claim 19, wherein the outer end of the each radial slot of the radial slots is located at a same radial distance from the airgap; and
the slot width is less than or equal to the airgap along the slot length.
